(19) United States
(12) Patent Application Publication
(10) Pub. No.: US 2026/0098737 A1
(43) Pub. Date: Apr. 9, 2026

(54) Method and System for Route Planning for Automated Driving Vehicles

(71) Applicant: Bayerische Motoren Werke Aktiengesellschaft, Muenchen (DE)

(72) Inventors: Jakob HUEMER, Muenchen (DE); Kathrin LEHMEYER, Muenchen (DE)

(21) Appl. No.: 19/114,832

(22) PCT Filed: Sep. 1, 2023
(86) PCT No.: PCT/EP2023/074055

§ 371 Date: Mar. 25, 2025

(30) Foreign Application Priority Data
Sep. 26, 2022 (DE) 10 2022 124 632.9

(51) Int. Cl. G01C 21/34

(52) U.S. Cl. CPC G01C 21/3453

(57) ABSTRACT

The present disclosure relates to a method for route planning for automated driving vehicles, which includes determining a plurality of candidate driving routes from a starting point to a destination; determining an availability of a driving assistance function for automated driving for each candidate driving route of the plurality of candidate driving routes; and selecting a candidate driving route from the plurality of candidate driving routes, having a maximum availability of the driving assistance function for automated driving, as final driving route.

### BACKGROUND AND SUMMARY

The present disclosure relates to a method for route planning for vehicles driving in an automated manner, a storage medium for carrying out the method, a system for route planning for vehicles driving in an automated manner, and a vehicle having such a system. The present disclosure relates in particular to a route calculation for efficient use of one or more driver assistance functions for automated driving.

Driver assistance systems for automated driving are increasingly gaining importance. Automated driving can take place with various degrees of automation. Exemplary degrees of automation are assisted, semiautomated, conditionally automated, highly automated, or fully automated driving. The abovementioned five degrees of automation correspond to SAE levels 1 to 5 of the standard SAE J3016 (SAE-Society of Automotive Engineering) according to the status of Apr. 30, 2021. In fully automated driving (SAE level 5), all aspects of the dynamic driving task can be carried out by the system under any roadway and environmental condition which is also managed by a human driver.

Current routing systems are capable of rapidly and efficiently calculating optimum routes from a starting point to a route destination and a prediction for arrival times and/or travel times. In general, only topological properties (for example, turning links) and dynamic properties (for example, current speed, construction sites) of route sections are taken into consideration for the route planning in this case. More extensive route analysis often does not take place, which, in particular in combination with a driver assistance system for automated driving, can result in inefficient route planning and/or dissatisfaction in the user of the driver assistance system, depending on its functional embodiment.

It is an object of the present disclosure to specify a method for route planning for vehicles driving in an automated manner, a storage medium for carrying out the method, a system for route planning for vehicles driving in an automated manner, and a vehicle having such a system which enable efficient route planning for vehicles driving in an automated manner. In particular, it is an object of the present disclosure to enable maximum availability of an automated driving mode and therefore robustness of the available system.

This object is achieved by the subject matter of the independent claims. Advantageous embodiments are specified in the dependent claims.

According to an independent aspect of the present disclosure, a method for route planning for vehicles driving in an automated manner, in particular motor vehicles, is specified. The method comprises determining a plurality of candidate driving routes from a starting point to a destination; determining an availability of a driver assistance function for automated driving for each candidate driving route of the plurality of candidate driving routes; and selecting one candidate driving route from the plurality of candidate driving routes, which has a maximum availability of the driver assistance function for automated driving, as the final driving route.

According to the invention, a plurality of candidate driving routes is assessed with respect to an availability of a driver assistance function for automated driving during the route planning. As the final route, the driving route is selected from the plurality of candidate driving routes which offers maximum availability of the driver assistance function, optionally also combined with a lowest risk (for example, driving routes in the morning at 7:45 a.m. past schools can be avoided). Efficient route planning can therefore be enabled for vehicles driving in an automated manner, by which a level of user satisfaction can be increased. Moreover, a level of traffic safety can be increased due to the maximum availability of the driver assistance function, since human driving errors can be avoided.

Optionally, multiple assistance systems can participate in the method according to the invention. For example, a calculation for the route planning can be generated from various signals of the assistance systems. Trained algorithms can optimize the calculation of the route planning here, for example, also live.

The term “automated driving” is understood in the context of the document as driving with automated longitudinal and/or lateral guidance. Automated driving can be, for example, driving for a longer time on specific route types (e.g., suburban roads, urban roads, freeways, city freeways, rural roads, or city roads) or driving for a limited time in the context of parking. The term “automated driving” comprises automated driving with an arbitrary degree of automation. Exemplary degrees of automation are assisted, semiautomated, conditionally automated, highly automated, and fully automated driving (each with increasing degree of automation). The abovementioned five degrees of automation correspond to SAE levels 1 to 5 of the standard SAE J3016 (SAE—Society of Automotive Engineering) according to the status of Apr. 30, 2021.

In assisted driving (SAE level 1), the system carries out longitudinal or lateral guidance in specific driving situations. In semiautomated driving (SAE level 2), the system takes over the longitudinal and lateral guidance in specific driving situations, wherein the driver has to continuously monitor the system as in assisted driving. In conditionally automated driving (SAE level 3), the system takes over the longitudinal and lateral guidance in specific driving situations without the driver having to continuously monitor the system; however, the driver has to be capable within a certain time of taking over the vehicle guidance upon request by the system. In highly automated driving (SAE level 4), the system takes over the vehicle guidance in specific driving situations, even if the driver does not react to a request to intervene, so that the driver is omitted as a fallback level. In fully automated driving (SAE level 5), all aspects of the dynamic driving task can be carried out by the system under any roadway and environmental condition, which is also managed by a human driver.

In addition, the term “at least semiautomated driving or maneuvering” is also understood in the context of the document as semiautomated, conditionally automated, highly automated, or fully automated driving. In other words, the term “at least semiautomated driving”is therefore understood as a degree of automation from SAE level 2 inclusive.

The driver assistance function which is taken into consideration in the route planning according to the invention is preferably configured for automated driving according to SAE level 2, SAE level 3, SAE level 4, or SAE level 5.

The method for route planning preferably uses a routing algorithm. In such a routing algorithm, for example, a path selection can be made in that decision criteria (metrics) are offset with weighting factors for each possible path. These can also change over the running time because the algorithm has learned from the preferences of the driver and makes use of this data knowledge.

The determination of the availability of the driver assistance function for automated driving preferably takes place based on a functional embodiment of the driver assistance function or the driver assistance system and/or the operational design domain (ODD) of the driver assistance function. In other words, the answer to the question as to whether a driving route or route sections thereof are suitable for automated driving can depend on the functional embodiment of the driver assistance function or the driver assistance system and/or the ODD (for example, SAE level 2, 3, or 4). For example, some driver assistance functions or corresponding functional embodiments enable assistance when traveling on roads having different specific lane widths and/or different speed ranges (for example, minimum speeds or maximum speeds) than other driver assistance functions or corresponding functional embodiments.

Each candidate driving route preferably comprises a plurality of route sections, which possibly differ in their route characteristics (e.g., lane width, permissible or allowed maximum speed, etc.). In particular, a plurality of candidate driving routes is present between the starting point and the destination, wherein each driving route of the plurality of candidate driving routes can have a plurality of route sections. The plurality of candidate driving routes can have at least partially different route sections in this case.

For each route section of the plurality of route sections of a candidate driving route it can be determined whether automated driving is possible in accordance with the ODD. For example, not every route section of the plurality of route sections of a candidate driving route can be suitable for automated driving, for example, due to route properties, speed ranges, and/or weather conditions. The route planning according to the invention assesses the plurality of route sections of each candidate driving route with respect to the possibility for automated driving so that at the end the candidate driving route is determined as the final driving route, the route sections of which in total maximize an availability for automated driving.

Determining a plurality of candidate driving routes from a starting point to a destination preferably comprises ascertaining possible driving routes from the starting point to the destination; and selecting the plurality of candidate driving routes from the possible driving routes based on at least one selection criterion. Unsuitable driving routes can therefore already be rejected from the outset before the availability check, so that an efficiency of the route planning can be further improved.

Preferably, the at least one selection criterion is selected from the group which comprises or consists of a chronological selection criterion, a route-specific selection criterion, and a driver-individual selection criterion.

The chronological selection criterion can be, for example, a (for example, latest) arrival time at the destination and/or a maximum driving duration or travel time. In a further example, a fastest route can be used as a reference in order to select the plurality of candidate driving routes from the possible driving routes. For example, all driving routes can be rejected, the estimated driving duration or travel time of which is an x-multiple of the driving duration or travel time of the fastest driving route. In this case, x is greater than 1 and can be a whole number (for example, 2) or rational number (for example, 1.5).

The route-specific selection criterion can relate, for example, to a road condition. For example, all driving routes can be rejected, the road condition (at least in some sections) of which is disadvantageous for the vehicle and/or the driver, for example, due to potholes and/or gravel surface.

The driver-individual selection criterion can comprise preferences of the driver. For example, it can be known that the driver avoids specific road categories, such as freeways. In this case, all driving routes can be rejected which comprise (at least in some sections) such a road category.

Preferably, the availability of the driver assistance function for automated driving is a time-related availability or a distance-related availability. The time-related availability relates here to a time span of the driving duration or travel time, during which automated driving is possible. The distance-related availability, in contrast, relates to a driving distance or driving route, over which automated driving is possible.

Preferably, the determination of the availability of the driver assistance function for automated driving is carried out based on internal information which is stored in the vehicle and/or is collected by the vehicle. The information stored in the vehicle can comprise, for example, digital map data, historic information on driving routes, information on preferences of the driver, etc., but is not restricted thereto. The information collected by the vehicle can comprise historic information on driving routes, (historic) information on preferences of the driver, etc., but is not restricted thereto.

Additionally or alternatively, the determination of the availability of the driver assistance function for automated driving is carried out based on external information which is provided to the vehicle by at least one external unit. The at least one external unit can comprise or be, for example, a central unit, such as a backend, and/or at least one foreign vehicle. The term “central unit” also comprises, in some embodiments, infrastructure-to-X, thus, for example, signals from control units which a city installs.

The vehicle can be connected via a communication connection to the at least one external unit in order to receive the external information. The communication connection can be implemented, for example, by means of a mobile network, such as an LTE network or 5G network. In a further example, a car2car communication can be used in order to receive the external information directly from a foreign vehicle.

Preferably, the external information is provided by a vehicle fleet. In particular, the vehicles of the vehicle fleet can transmit data relevant for the availability check according to the invention (for example, system drops on specific route sections) to a backend. The backend can collect the data and provide it as needed to other vehicles for the availability check according to the invention.

The determination of the availability of the driver assistance function for automated driving preferably takes place based on road categories along the candidate driving routes (for example, according to functional road class, FRC, with prioritization according to low FRC1).

Additionally or alternatively, the determination of the availability of the driver assistance function for automated driving can take place based on intersection properties on the candidate driving routes, for example, based on the presence of a traffic signal at an intersection, a left or right turn at the intersection, a presence of a turn lane at the intersection, etc.

Additionally or alternatively, the determination of the availability of the driver assistance function for automated driving can take place based on turn situations along the candidate driving routes, for example, based on a left or right turn, a presence of a turn lane, etc. For example, route sections or driving routes without left turns can be prioritized.

Additionally or alternatively, the determination of the availability of the driver assistance function for automated driving can take place based on driver assistance function approvals along the candidate driving routes. For example, a comparison with stored information on road approvals of ADAS (advanced driver assistance system) systems can be carried out, wherein a prioritization of approved route sections can be performed.

Additionally or alternatively, the determination of the availability of the driver assistance function for automated driving can take place based on a traffic volume along the candidate driving routes. The traffic volume is preferably divided into a motorized traffic volume (passenger vehicles, trucks, etc.) and a nonmotorized traffic volume (pedestrians, cyclists, etc.). In some embodiments, route sections having low nonmotorized traffic volume can be prioritized. For example, route sections in the surroundings of schools can be avoided at certain times.

Additionally or alternatively, the determination of the availability of the driver assistance function for automated driving can take place based on an average speed along the candidate driving routes. For example, route sections or corresponding driving routes having an availability for level 3 speed ranges can be prioritized.

Additionally or alternatively, the determination of the availability of the driver assistance function for automated driving can take place based on curve radii on the candidate driving routes. For example, it can be that tight curve radii cannot be driven through in an automated manner using a defined set or directed speed with some driver assistance functions, so that route sections having such tight curve radii can be avoided.

Additionally or alternatively, the determination of the availability of the driver assistance function for automated driving can take place based on forced deactivation scenarios of the driver assistance function for automated driving along the candidate driving routes. In this case, a forced deactivation designates ending of the automated driving and transfer of the vehicle control to the driver due to a current condition.

For example, route sections which could result in a forced deactivation of the driver assistance can be avoided. A forced deactivation can take place, for example, due to weather conditions (for example, temperature, precipitation, wind, etc.), atmospheric conditions (for example, wet, slippery, snow, ground frost, etc.), and/or road conditions (for example, roadway quality, quality of the ground marking, lane width, etc.).

Additionally or alternatively, the determination of the availability of the driver assistance function for automated driving can take place based on historic deactivations of the driver assistance function for automated driving along the candidate driving routes. For example, route sections can be known from fleet data on which a forced deactivation often occurs. Such route sections can then be avoided.

Additionally or alternatively, the determination of the availability of the driver assistance function for automated driving can take place based on a level of the sun along the candidate driving routes. For example, it can be that a camera-based surroundings sensor system no longer supplies robust surroundings recognition when the sun is at a low level and there is direct incident light, so that a forced deactivation of the driver assistance function can occur. Accordingly, route sections on which the level of the sun could result in such a forced deactivation can be avoided.

The method preferably furthermore comprises outputting a driver notification with respect to the final driving route. In particular, the final driving route can be proposed to the driver. The driver can select or confirm the final driving route, by which, for example, a destination guidance is started. For the manual selection of the driving route by the driver, information on the availability of the driver assistance for each driving route can be provided to the driver, for example, a prediction of the duration and/or distance of the availability.

Preferably, the vehicle comprises at least one output device for outputting the driver notification. The at least one output device can comprise at least one display device and/or at least one loudspeaker. The at least one display device can comprise a display, in particular an LCD display, a plasma display, or an OLED display. Additionally or alternatively, the at least one display device can comprise a projection device configured to show information directly in the field of view of the driver, in particular to project it on a windshield. In some embodiments, the at least one output device can be a central information output device of an infotainment system, such as a head unit or a pillar-to-pillar display. The at least one output device is preferably permanently installed in the vehicle.

The method preferably furthermore comprises detecting, by a surroundings sensor system of the vehicle, surroundings data; and carrying out automated driving along the final driving route (or on the route sections of the final driving route suitable for automated driving) based on the surroundings data. The surroundings data or a corresponding sensor-based surroundings model of the vehicle can therefore form an influencing factor, for example, to prevent collisions of the vehicle with objects or other road users.

The surroundings sensor system preferably comprises at least one LiDAR system and/or at least one radar system and/or at least one camera and/or at least one ultrasound system and/or at least one laser scanner. The surroundings sensor system can provide the environmental data (also referred to as “surroundings data”), which depict a surrounding area of the vehicle.

The method preferably furthermore comprises actuating the vehicle driving in an automated manner such that the vehicle follows the final driving route or the route sections of the final driving route suitable for automated driving. In particular, the vehicle can follow the final driving route in that the vehicle compares its current position with the planned position and adapts the steering and/or speed.

According to a further independent aspect of the present disclosure, a software (SW) program is specified. The SW program can be configured to be executed on one or more processors, and to thus carry out the method described in this document for route planning for vehicles driving in an automated manner.

According to a further independent aspect of the present disclosure, a non-transitory storage medium is specified. The storage medium can comprise an SW program, which is configured to be executed on one or more processors, and to thus carry out the method described in this document for route planning for vehicles driving in an automated manner.

According to a further independent aspect of the present disclosure, software having program code is specified. The software is configured to carry out the method for route planning for vehicles driving in an automated manner when the software runs on one or more software-controlled apparatuses.

According to a further independent aspect of the present disclosure, a system for route planning for vehicles driving in an automated manner is specified. The system comprises one or more processors; and at least one memory, which is connected to the one or more processors and contains instructions which can be executed by the one or more processors in order to carry out the method described in this document for route planning for vehicles driving in an automated manner.

The system is configured in particular to carry out the method described in this document for route planning for vehicles driving in an automated manner. The method can implement the aspects of the system described in this document.

A processor or a processor module is a programmable arithmetic unit, thus a machine or an electronic circuit, which controls other elements according to transferred commands and propels an algorithm (process) in this case.

The system is preferably a driver assistance system for automated driving or is at least partially comprised in such a driver assistance system or has a communication connection to the driver assistance system.

Preferably, the entire system is integrated in the vehicle. The present disclosure is not limited thereto, however, and parts of the system or the entire system, for example, a routing module for the route planning according to the invention, can be implemented outside the vehicle, for example, in a central unit or a backend. In this case, a communication connection can be present between the vehicle and the central unit in order to transmit the accurate route to the vehicle and to enable the functionalities of the driver assistance system described in this document. The communication connection can be implemented, for example, by means of a mobile network, such as an LTE network or 5G network.

According to a further independent aspect of the present disclosure, a vehicle, in particular a motor vehicle, is specified. The vehicle comprises the system for route planning for vehicles driving in an automated manner and/or a driver assistance system for automated driving according to the embodiments of the present disclosure.

The term vehicle comprises passenger vehicles, trucks, buses, caravans, motorcycles, etc., which are used to convey people, goods, etc. In particular, the term comprises motor vehicles for conveying people.

### BRIEF DESCRIPTION OF THE DRAWINGS

Exemplary embodiments of the disclosure are illustrated in the drawings and will be described in more detail hereinafter. In the figures:

FIG. 1 schematically shows a vehicle having a driver assistance system for automated driving according to embodiments of the present disclosure, and

FIG. 2 shows a flow chart of a method for route planning for vehicles driving in an automated manner according to embodiments of the present disclosure.

### DETAILED DESCRIPTION OF THE DRAWINGS

Identical reference signs are used for identical and identically acting elements hereinafter, if not indicated otherwise.

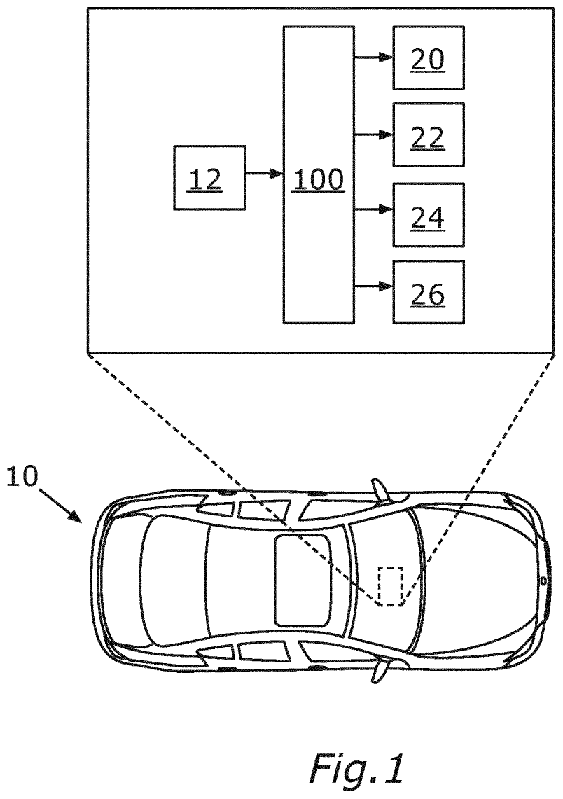

FIG. 1 schematically shows a vehicle 10 having a driver assistance system 100 for automated driving according to embodiments of the present disclosure.

During the automated driving, the longitudinal and/or lateral guidance of the vehicle 10 takes place automatically. The driver assistance system 100 thus takes over the vehicle control. For this purpose, the driver assistance system 100 controls the drive 20, the transmission 22, the hydraulic service brake 24, and the steering 26 via intermediate units (not shown).

To plan and carry out the automated driving, surroundings information of a surroundings sensor system which observes the vehicle surroundings is accepted by the driver assistance system 100. In particular, the vehicle can comprise at least one surroundings sensor 12 which is configured to record surroundings data that specify the vehicle surroundings. The at least one surroundings sensor 12 can comprise, for example, one or more LiDAR systems, one or more radar systems, one or more laser scanners, one or more ultrasonic sensors, and/or one or more cameras.

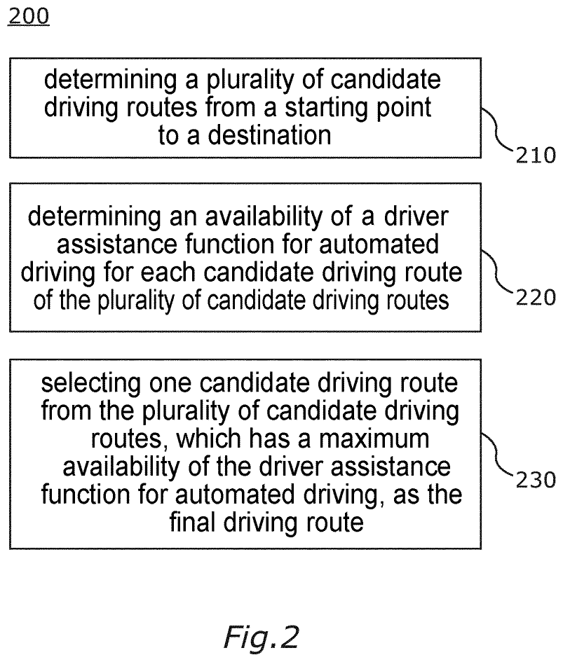

FIG. 2 schematically shows a flow chart of a method 200 for route planning for vehicles driving in an automated manner according to embodiments of the present disclosure. The method 200 can be implemented by corresponding software, which is executable by one or more processors (such as a CPU).

The method 200 comprises, in block 210, determining a plurality of candidate driving routes from a starting point to a destination; in block 220, determining an availability of a driver assistance function for automated driving for each candidate driving route of the plurality of candidate driving routes; and in block 230, selecting one candidate driving route from the plurality of candidate driving routes, which has a maximum availability of the driver assistance function for automated driving, as the final driving route.

In one exemplary embodiment of the method 200 according to the invention, the driver can initially select an option “maximum availability of driver assistance” in a configuration menu. The method 200 can then apply a routing algorithm which calculates driving routes such that the vehicle can remain as long as possible and without interruptions as much as possible in the automated driving mode.

For this purpose, a selection of possible driving routes to an input destination can initially be ascertained according to a time criterion. For example, initially driving routes can be selected, the estimated time expenditure of which is less than twice the time requirement for a fastest route. The selection made can then be assessed with respect to the maximum availability of the driver assistance function, for example, in that the selected driving routes are compared with information from map material in the vehicle and/or with data from a backend.

In the assessment of the selected driving routes, a plurality of different criteria or aspects can be taken into consideration. These criteria comprise, for example, road categories, a type and/or complexity of intersections and turn situations, road approvals, a traffic volume, average speeds, curve radii, turn procedures, forced deactivations of the driver assistance function, system drops from customer fleet data, etc. The present disclosure is not restricted to these criteria, however, and other criteria can be used to assess the selected driving routes, which are suitable for checking the availability of the driver assistance function for automated driving.

The ascertained route having the maximum driver assistance can then be adopted in the route guidance of the vehicle.

According to the invention, a plurality of candidate driving routes is assessed with respect to an availability of a driver assistance function for automated driving in the route planning. As the final route, that driving route is selected from the plurality of candidate driving routes which offers maximum availability of the driver assistance function. Efficient route planning for vehicles driving in an automated manner can therefore be enabled, by which a level of user satisfaction can be increased. Moreover, due to the maximum availability of the driver assistance function, a level of traffic safety can be increased, since human driving errors can be avoided.

Although the invention was illustrated and explained in more detail by preferred exemplary embodiments, the invention is not thus restricted by the disclosed examples and other variations can be derived therefrom by a person skilled in the art without departing from the scope of the invention. It is therefore clear that a plurality of possible variations exists. It is also clear that embodiments mentioned as examples actually only represent examples, which are not to be interpreted in any way as a delimitation, for example, of the scope of protection, the possible applications, or the configuration of the invention. Rather, the preceding description and the description of the figures make a person skilled in the art capable of specifically implementing the exemplary embodiments, wherein a person skilled in the art who is aware of the disclosed concept of the invention can perform a variety of modifications, for example, with respect to the function or the arrangement of individual elements mentioned in an exemplary embodiment, without departing from the scope of protection defined by the claims and their legal equivalents, such as more extensive explanations in the description.

1.-10. (canceled)

11. A method for route planning for vehicles driving in an automated manner, comprising:
determining a plurality of candidate driving routes from a starting point to a destination;
determining an availability of a driver assistance function for automated driving for each candidate driving route of the plurality of candidate driving routes; and
selecting a candidate driving route from the plurality of candidate driving routes, which has a maximum availability of the driver assistance function for automated driving, as the final driving route.

12. The method according to claim 11, wherein the determination of the plurality of candidate driving routes from the starting point to the destination comprises:
ascertaining possible driving routes from the starting point to the destination; and
selecting the plurality of candidate driving routes from the possible driving routes based on at least one selection criterion.

13. The method according to claim 12, wherein the at least one selection criterion is selected from a group which consists of a chronological selection criterion, a route-specific selection criterion, and a driver-individual selection criterion.

14. The method according to claim 11, wherein the availability of the driver assistance function for automated driving is a time-related availability or a distance-related availability.

15. The method according to claim 12, wherein the availability of the driver assistance function for automated driving is a time-related availability or a distance-related availability.

16. The method according to claim 13, wherein the availability of the driver assistance function for automated driving is a time-related availability or a distance-related availability.

17. The method according to claim 11, wherein the determination of the availability of the driver assistance function for automated driving takes place based on internal information, which is stored in the vehicle and/or collected by the vehicle, and/or external information, which is provided to the vehicle by at least one external unit.

18. The method according to claim 12, wherein the determination of the availability of the driver assistance function for automated driving takes place based on internal information, which is stored in the vehicle and/or collected by the vehicle, and/or external information, which is provided to the vehicle by at least one external unit.

19. The method according to claim 13, wherein the determination of the availability of the driver assistance function for automated driving takes place based on internal information, which is stored in the vehicle and/or collected by the vehicle, and/or external information, which is provided to the vehicle by at least one external unit.

20. The method according to claim 17, wherein the external information is provided by a central unit and/or a vehicle fleet.

21. The method according to claim 11, wherein the determination of the availability of the driver assistance function for automated driving takes place based on at least one of the following aspects:
road categories along the candidate driving routes;
intersection properties on the candidate driving routes;
turn situations along the candidate driving routes;
driver assistance function approvals along the candidate driving routes;
a traffic volume along the candidate driving routes, including a motorized traffic volume and/or a nonmotorized traffic volume;
average speeds along the candidate driving routes;
curve radii on the candidate driving routes;
forced deactivation scenarios of the driver assistance function for automated driving along the candidate driving routes;
historic deactivations of the driver assistance function for automated driving along the candidate driving routes; and
a level of the sun along the candidate driving routes.

22. The method according to claim 12, wherein the determination of the availability of the driver assistance function for automated driving takes place based on at least one of the following aspects:
road categories along the candidate driving routes;
intersection properties on the candidate driving routes;
turn situations along the candidate driving routes;
driver assistance function approvals along the candidate driving routes;
a traffic volume along the candidate driving routes, including a motorized traffic volume and/or a nonmotorized traffic volume;
average speeds along the candidate driving routes;
curve radii on the candidate driving routes;
forced deactivation scenarios of the driver assistance function for automated driving along the candidate driving routes;
historic deactivations of the driver assistance function for automated driving along the candidate driving routes; and
a level of the sun along the candidate driving routes.

23. The method according to claim 13, wherein the determination of the availability of the driver assistance function for automated driving takes place based on at least one of the following aspects:
road categories along the candidate driving routes;
intersection properties on the candidate driving routes;
turn situations along the candidate driving routes;
driver assistance function approvals along the candidate driving routes;
a traffic volume along the candidate driving routes, including a motorized traffic volume and/or a nonmotorized traffic volume;
average speeds along the candidate driving routes;
curve radii on the candidate driving routes;
forced deactivation scenarios of the driver assistance function for automated driving along the candidate driving routes;
historic deactivations of the driver assistance function for automated driving along the candidate driving routes; and
a level of the sun along the candidate driving routes.

24. The method according to claim 14, wherein the determination of the availability of the driver assistance function for automated driving takes place based on at least one of the following aspects:
road categories along the candidate driving routes;
intersection properties on the candidate driving routes;
turn situations along the candidate driving routes;
driver assistance function approvals along the candidate driving routes;
a traffic volume along the candidate driving routes, including a motorized traffic volume and/or a nonmotorized traffic volume;
average speeds along the candidate driving routes;
curve radii on the candidate driving routes;
forced deactivation scenarios of the driver assistance function for automated driving along the candidate driving routes;
historic deactivations of the driver assistance function for automated driving along the candidate driving routes; and
a level of the sun along the candidate driving routes.

25. The method according to claim 17, wherein the determination of the availability of the driver assistance function for automated driving takes place based on at least one of the following aspects:
road categories along the candidate driving routes;
intersection properties on the candidate driving routes;
turn situations along the candidate driving routes;
driver assistance function approvals along the candidate driving routes;
a traffic volume along the candidate driving routes, including a motorized traffic volume and/or a nonmotorized traffic volume;
average speeds along the candidate driving routes;
curve radii on the candidate driving routes;
forced deactivation scenarios of the driver assistance function for automated driving along the candidate driving routes;
historic deactivations of the driver assistance function for automated driving along the candidate driving routes; and
a level of the sun along the candidate driving routes.

26. A non-transitory computer-readable medium storing a program configured to be executed on one or more processors and to execute instructions for route planning for vehicles driving in an automated manner, the instructions comprising:
determining a plurality of candidate driving routes from a starting point to a destination;
determining an availability of a driver assistance function for automated driving for each candidate driving route of the plurality of candidate driving routes; and
selecting a candidate driving route from the plurality of candidate driving routes, which has a maximum availability of the driver assistance function for automated driving, as the final driving route.

27. A system for route planning for vehicles driving in an automated manner, comprising:
one or more processors; and
at least one memory, which is connected to the one or more processors and contains instructions which can be executed by the one or more processors in order to carry out the method for route planning for vehicles driving in an automated manner according to claim 11.

28. A motor vehicle comprising the system according to claim 27.
